(19) United States
(12) Patent Application Publication
(10) Pub. No.: US 2011/0095248 A1
(43) Pub. Date: Apr. 28, 2011

(54) Formed Loft Block

(75) Inventors: Thomas S. Young, Jamesville, NY (US); Rodney F. Kaiser, Syracuse, NY (US)

(73) Assignee: J. R. CLANCY, INC., Syracuse, NY (US)

(21) Appl. No.: 12/913,833

(22) Filed: Oct. 28, 2010

Related U.S. Application Data
(60) Provisional application No. 61/255,771, filed on Oct. 28, 2009.

(51) Int. Cl. B66D 3/04; B26D 3/00

(52) U.S. Cl. 254/390; 83/13

(57) ABSTRACT

The present invention is directed to a mounting member for use in a pulley assembly that is generally U-shaped and includes: (i) a side wall portion; (ii) a base portion; and (iii) a stiffness enhancement portion. The side wall portion is one vertical arm of the U-shape and serves to rotationally mount the pulley. The base portion is the bottom of the U-shape and is generally used to mount the to a structure (for example, a beam in a theatre). The stiffness enhancement portion is the other vertical arm of the U-shape and serves at least to enhance stiffness so that higher capacity pulley assemblies with unitary side plate/base plate members may be achieved.

The present application claims priority to U.S. provisional patent application No. 61/255,771, filed on Oct. 28, 2009; all of the foregoing patent-related document(s) are hereby incorporated by reference herein in their respective entirety(ies).

### BACKGROUND OF THE INVENTION

1. Field of the Invention

The present invention relates to pulley assemblies and more particularly to high weight capacity pulley assemblies for use in theatres.

2. Description of the Related Art

A loft block is an assembly made of a pulley wheel with side plates and hardware for being mounted to a structure (for example, mounting holes). An example of this is shown in FIG. 1A at loft block assembly 300 including base angle 301, which is designed to be mounted to building structure (such as a rafter in the loft of a theatre). A loft block is used in a theatre to change the direction of a lift line, typically from a horizontal direction to a vertical direction. The lift lines are used to hoist scenery, battens, lighting equipment and other theatre related loads. Typically, the loft block is mounted in a part of the stage house known as the loft. Conventionally, loft block assemblies include side plates of steel with base plates of steel angle. This design requires that the side plates and base plate be connected to each other (for example, by bolting and/or welding). Loft blocks are conventionally mounted in an upright position (that is, base plate faces down), or in an underhung position (that is, base plate faces up).

FIG. 1B shows another conventional loft block assembly 200. Assembly 200 includes: pulley member 202; axle sub-assembly 204; first mounting member 206 (including side plate portion 206a and base plate portion 206b); second mounting member 208 (including side plate portion 208a and base plate portion 208b); spacer sub-assemblies 220; building member 222; and loft block securing sub-assemblies 224.

One conventional pulley assembly is disclosed in a one page brochure called “Unitized Loft Block” by Secoa and on the internet at www.secoa.com/specsBrochures%5Cunitizedloftblockcutsheet.pdf (published as of 13 Oct. 2010). As shown in FIG. 1B, side plate portion 206a and base plate portion 206b meet to form an L-shaped first mounting member. The second mounting member has a similar L-shaped geometry when viewed from the end. Each of the two mounting members are unitary (that is, move as a single piece part) and integrally formed (that is, made from a single piece of homogenous material). More specifically, each mounting member is made from a metal sheet that is cut to shape and bent to form the perpendicular arms of the L-shape. The longer arm of the L-shape supports the axle sub-assembly. The axle sub-assembly rotatably mechanically connects (see DEFINITIONS section) the pulley member directly to the mounting members and indirectly to the building. Base plate portions 206b,208b are directly mechanically connected to the building by the loft block securing sub-assemblies. However, this design of assembly 200 is only low capacity, meaning that it can only support relatively low loads on the pulley member by the cable that is wound about a portion of the pulley in use. Assembly 200 is believed to be limited to such applications because of its very short base angle, and a relative lack of stiffness over each of its L-shaped mounting members 206,208.

Description Of the Related Art Section Disclaimer: To the extent that specific publications are discussed above in this Description of the Related Art Section, these discussions should not be taken as an admission that the discussed publications (for example, published patents) are prior art for patent law purposes. For example, some or all of the discussed publications may not be sufficiently early in time, may not reflect subject matter developed early enough in time and/or may not be sufficiently enabling so as to amount to prior art for patent law purposes. To the extent that specific publications are discussed above in this Description of the Related Art Section, they are all hereby incorporated by reference into this document in their respective entirety(ies).

### BRIEF SUMMARY OF THE INVENTION

The present invention is directed to a mounting member for use in a pulley assembly that is generally U-shaped and includes: (i) a side wall portion; (ii) a base portion; and (iii) a stiffness enhancement portion. The side wall portion is one vertical arm of the U-shape and serves to rotationally mount the pulley. The base portion is the bottom of the U-shape and is generally used to mount the block (or pulley assembly) to a structure (for example, a beam in a theatre). The stiffness enhancement portion is the other vertical arm of the U-shape and serves at least to enhance stiffness so that higher capacity pulley assemblies with unitary side plate/base plate members may be achieved. In some preferred embodiments, the side plate portion will be considerably longer than either the base portion or the stiffness enhancement portion. Preferably the U-shaped mounting member has rounded, rather than sharp corners, which roundness can further increase the stiffness and/or strength.

According to another aspect of the present invention, mounting members for use in loft block assemblies have a “nesting” profile on their top edges, as shown in FIG. 3. Preferably, these nesting, mounting members are U-shaped, as viewed from the end, as described in the previous paragraph, but other profiles may also be possible. Although the focus of the embodiments discussed herein are pulley assemblies for theatre use (for example, loft blocks), it is believed that the present invention may have much wider application, and be useful for pulley assemblies (or formed blocks) designed for use in many different work environments (now known or to be developed in the future).

Various embodiments of the present invention may exhibit one or more of the following objects, features and/or advantages:

(i) adds significant strength to the base angle;

(ii) higher capacity loft block assembly;

(iii) loft block assembly with unitary plates that is suitable for a greater range of load supporting applications;

(iv) no welding and/or other piece part joining processes required to form mounting member;

(v) less expensive mounting member;

(vi) mounting member that is easier to make;

(vii) compatible with a hole and slot geometry (herein called the “Universal Loft Block Pattern”) that allows loft blocks to be sent to the jobsite with a pattern that will work in virtually all commonly occurring application, and reduces or eliminates the need to be punched or drilled at the jobsite;

(viii) reduces material waste during manufacturing process;

(ix) added strength reduces or eliminates buckling and thereby allows base angles (for example 24 inch long base angles) to be used; and

(x) mounting members with top edges shaped to have “nesting profiles” reduces material waste.

According to an aspect of the present invention, a pulley assembly includes a pulley member, an axle sub-assembly, and a first mounting member (defining a base side). The first mounting member includes a side wall portion, as base portion and a stiffness enhancing portion. The pulley member is rotationally mechanically connected to the side wall portion of the first mounting member by the axle sub-assembly. The first mounting member is generally U-shaped with the base portion forming the bottom of the U-shape and the side wall portion and the stiffness enhancing portion forming the arms of the U-shape.

According to a further aspect of the present invention, a pulley assembly includes a pulley member, an axle sub-assembly, a first mounting member (defining a base side), and a second mounting member (defining a base side). The first mounting member includes at least a side wall portion that defines a non-base edge. The second mounting member includes at least a side wall portion that defines a non-base edge. The pulley member is rotationally mechanically connected to the side wall portion of the first mounting member by the axle sub-assembly. The pulley member is rotationally mechanically connected to the side wall portion of the second mounting member by the axle sub-assembly. The non-base edge of the first mounting member is shaped and sized to be suitable for substantially complete complementary nesting. The non-base edge of the second mounting member is shaped and sized to be suitable for substantially complete complementary nesting.

According to a further aspect of the present invention, a method is used to make a plurality of mounting member plates for use in pulley assemblies, the method includes the steps of: (i) providing a strip of material; and (ii) cutting a plurality of the mounting members plates out of the strip according to a cutting pattern. The cutting pattern is shaped and sized so that there is at least substantially complete complementary nesting.

### BRIEF DESCRIPTION OF THE DRAWINGS

The present invention will be more fully understood and appreciated by reading the following Detailed Description in conjunction with the accompanying drawings, in which:

FIGS. 1A and 1B are perspective views of prior art pulley assemblies;

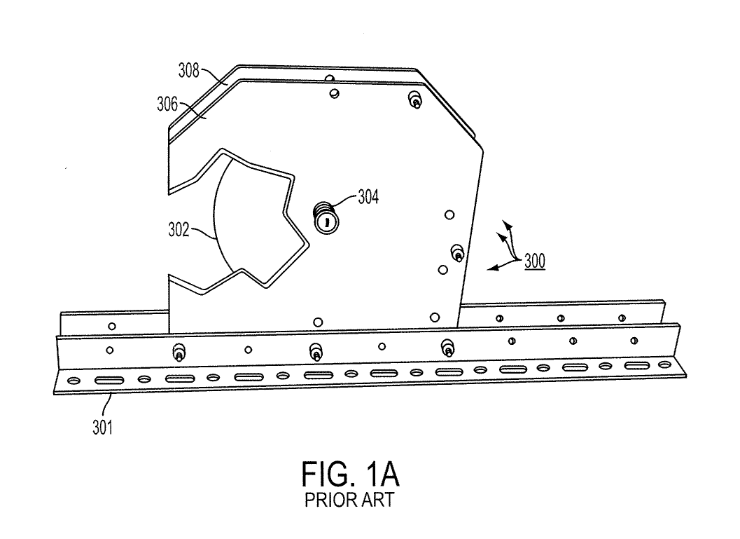

FIG. 2 is an orthographic end view of a first embodiment pulley assembly according to the present invention;

FIG. 3 is an orthographic side view of (pre-cut, pre-bent) mounting members used in the first embodiment pulley assembly; and.

FIG. 4 is an orthographic side view of (pre-cut, pre-bent) mounting members to be used in a second embodiment pulley assembly according to the present invention.

### DETAILED DESCRIPTION OF THE INVENTION

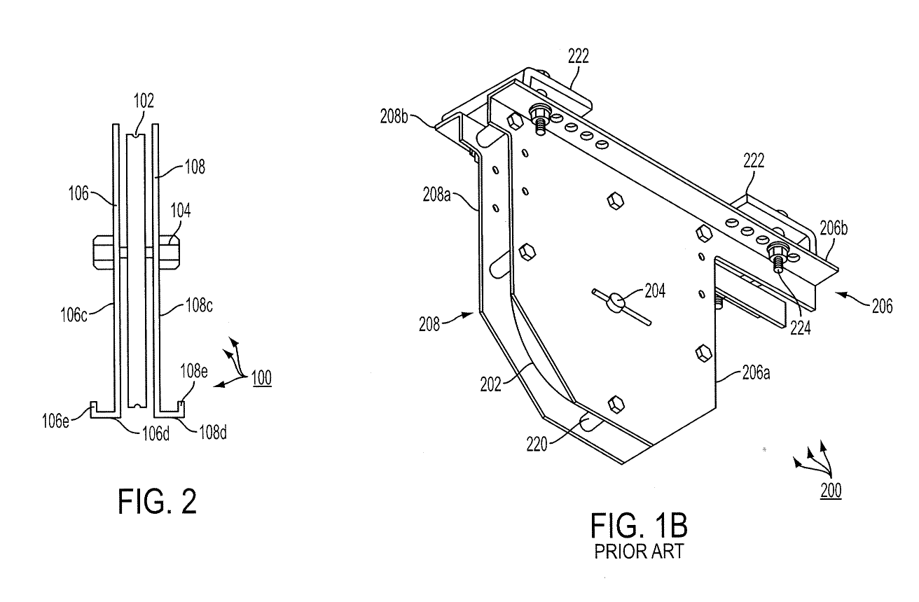

FIG. 2 shows loft block assembly 100, including: pulley wheel 102; pulley axle 104; first mounting member 106 (including side plate portion 106c, base plate portion 106d and stiffness enhancing portion 106e); and second mounting member 108 (including side plate portion 108c, base plate portion 108d and stiffness enhancing portion 108e). As shown in FIG. 2, each of the mounting members is generally U-shaped due to the presence of stiffness enhancing portions 106e,108e, although in this embodiment, and as shown in FIG. 2, one arm of the U-shape is longer than the other. Although the stiffness enhancing portions look relatively small, they greatly enhance stiffness which increases the size and/or load bearing capacity that can be used for a loft block assembly with sheet metal support members, and especially with sheet metal support members that are thin enough to be cut, bent and/or otherwise formed in a relatively inexpensive manner.

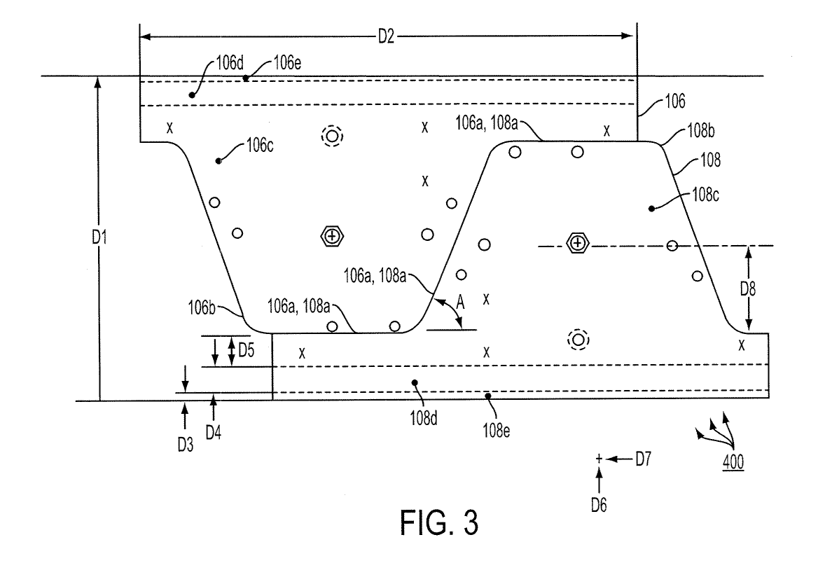

FIG. 3 shows a flat piece of metal 400 with: (i) outlines for cutting mounting members 106, 108; (ii) outlines for making holes corresponding to the preferred Universal Loft Block Pattern; (iii) dashed lines to show locations for bends to be made (to form the U-shape discussed above); and (iv) some exemplary dimensions. Preferred, exemplary dimensions (in inches unless otherwise indicated), as shown in FIG. 3, are as follows: (i) D1=16 strip; (ii) D2=24.75; (iii) D3=0.375; (iv) D4=1.125; (v) D5=1.75; (vi) D6=7.75; (vii) D7=9.375; and (viii) D8=7.75. At least for applications of present invention that are to be used as loft blocks, it is preferred that the loft block assembly be fully compatible with the Universal Loft Block Pattern, so that loft block assemblies according to the present invention may: (i) be used to replace conventional, pre-existing loft block assemblies; and/or (ii) may have some degree of interchangeability of component piece-parts with conventional loft block assemblies.

As shown in FIG. 3, the length D2 of the base portion and stiffness enhancing portion is preferably approximately 24 inches, which provides more flexibility in attachment. This relatively long length, typical of high capacity loft blocks, is facilitated by the strength enhancing U-shape discussed above.

As shown in FIG. 3, the top edges 106a, 108a of mounting members 106, 108 are designed to nest so that little or no material is wasted when the mounting members are cut from a 16 inch wide strip (D1) of sheet stock material. More specifically, the nesting top edges 106a,108a have a generally step-shaped profile and mutual interface (in the pre-cut state). Other step shapes could be used, such as shapes where angle A is a right angle, as opposed to the acute angle a of embodiment 400. As further shown in FIG. 3, the top edge 106a of mounting member 106 includes a portion 106b that was in a nesting relationship with a portion of another mounting member which has been cut away already. Similarly, the top edge 108a of mounting member 108 includes a portion 108b that was in a nesting relationship with a portion of another mounting member which has been cut away from the same strip of sheet stock. In other words, in this embodiment of the present invention, each mounting member is shaped so that its top edge nests with portions of top edges of two other similarly-shaped mounting members. As will be appreciated by those of ordinary skill in the art, the cuts are not required to be made in any specific order. The cutting may be accomplished by any cutting method now known, or to be developed in the future, such as lasers, water jets or hard tooling.

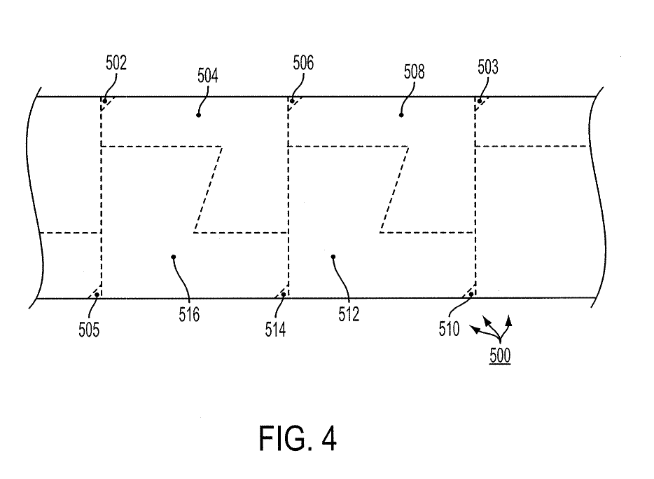

FIG. 4 shows a portion of a strip of metal 500 that is marked with dashed lines to show cuts that will be made in order to make mounting members for pulley assemblies. The regions defined by the dashed lines include: waste material regions 502, 503, 505, 506, 510, 514 and mounting member plate regions 504, 508, 512, 516. While FIG. 4 is not necessarily a preferred embodiment of the present invention, it is included to make the following points: (i) the nesting shapes of the present invention are not necessarily limited to the shape shown in FIG. 3; (ii) there may be some wasted material (even though it is preferable to have as little as possible); (iii) the entire nesting portion of the “top edge” (see DEFINITIONS section at “non-base edge”) is not required to face upwards; (iv) the mounting members may be shaped so that the top edge of a given member nests only with one other mounting member (instead of two as in the FIG. 3 embodiment); and (v) the mounting members may be flat (as opposed to the L-shaped profile discussed above or the U-shaped profile of mounting members 106,108).

Now that this nesting of mounting member profiles has been discussed generally in connection with embodiments 400 and 500, some terminology will be defined to discuss the nesting relationship with greater clarity. Embodiment 400 (see FIG. 3) is considered to exhibit “complete complementary nesting with overlap,” for reasons that will now be explained. It is considered as “complete complementary nesting” because the non-base edge of each mounting member interfaces with the non-base edge of at least one other mounting member(s) cut from the same strip (except for the mounting members cut from the ends of the strip, of course). In exemplary embodiment 400, the non-base edge of each mounting member will interface with the non-base edges of four other mounting members: two cut from the same side of the strip and two cut from the opposite side of the strip. Embodiment 400 is denominated as “nesting with overlap” because the non-base edge of a mounting member interfaces with more the non-base edge of more than one mounting member cut from the opposite side of the strip.

On the other hand, embodiment 500 is considered as “substantially complete complementary nesting without overlap,” for reasons that will now be explained. As shown in FIG. 4, part of the non-base edges of the mounting members are defined by the edges respectively surrounding and defining waste portions 502, 503, 505, 506, 510 and 514. These portions of the non-base edges do not nest because, in these vicinities, the non-base edge of a mounting member interfaces a waste portion, instead of interfacing a non-base edge portion of another mounting member cut from the same strip. Because these non-nesting portions exist in embodiment 500, there is not complete complementary nesting. Nevertheless, because the non-nesting portions of the non-base edges are quite small relative to the nesting portions there is still “substantially complete complementary nesting.” Also, the nesting is “without overlap” because the non-base edge of a mounting member will interface with the non-base edge of only one mounting member cut from the opposite side of the strip of sheet stock.

### DEFINITIONS

Any and all published documents mentioned herein shall be considered to be incorporated by reference, in their respective entireties, herein to the fullest extent of the patent law. The following definitions are provided for claim construction purposes:

Present invention: means at least some embodiments of the present invention; references to various feature(s) of the “present invention” throughout this document do not mean that all claimed embodiments or methods include the referenced feature(s).

Embodiment: a machine, manufacture, system, method, process and/or composition that may (not must) meet the embodiment of a present, past or future patent claim based on this patent document; for example, an “embodiment” might not be covered by any claims filed with this patent document, but described as an “embodiment” to show the scope of the invention and indicate that it might (or might not) covered in a later arising claim (for example, an amended claim, a continuation application claim, a divisional application claim, a reissue application claim, a re-examination proceeding claim, an interference count); also, an embodiment that is indeed covered by claims filed with this patent document might cease to be covered by claim amendments made during prosecution.

First, second, third, etc. (“ordinals”): Unless otherwise noted, ordinals only serve to distinguish or identify (e.g., various members of a group); the mere use of ordinals shall not be taken to necessarily imply order (for example, time order, space order).

Mechanically connected: Includes both direct mechanical connections, and indirect mechanical connections made through intermediate components; includes rigid mechanical connections as well as mechanical connection that allows for relative motion between the mechanically connected components; includes, but is not limited, to welded connections, solder connections, connections by fasteners (for example, nails, bolts, screws, nuts, hook-and-loop fasteners, knots, rivets, quick-release connections, latches and/or magnetic connections), force fit connections, friction fit connections, connections secured by engagement caused by gravitational forces, pivoting or rotatable connections, and/or slidable mechanical connections.

Non-base edge: any portion of the edge (that is non-major surface) of a side plate portion of a pulley mounting member that does not face the direction of the base of the pulley mounting member assembly.

To the extent that the definitions provided above are consistent with ordinary, plain, and accustomed meanings (as generally shown by documents such as dictionaries and/or technical lexicons), the above definitions shall be considered supplemental in nature. To the extent that the definitions provided above are inconsistent with ordinary, plain, and accustomed meanings (as generally shown by documents such as dictionaries and/or technical lexicons), the above definitions shall control.

Unless otherwise explicitly provided in the claim language, steps in method steps or process claims need only be performed in the same time order as the order the steps are recited in the claim only to the extent that impossibility or extreme feasibility problems dictate that the recited step order be used. This broad interpretation with respect to step order is to be used regardless of whether the alternative time ordering(s) of the claimed steps is particularly mentioned or discussed in this document—in other words, any step order discussed in the above specification shall be considered as required by a method claim only if the step order is explicitly set forth in the words of the method claim itself. Also, if some time ordering is explicitly set forth in a method claim, the time ordering claim language shall not be taken as an implicit limitation on whether claimed steps are immediately consecutive in time, or as an implicit limitation against intervening steps.

What is claimed is:

1. A pulley assembly comprising:
a pulley member;
an axle sub-assembly; and
a first mounting member defining a base side;
wherein:
the first mounting member includes a side wall portion, a base portion and a stiffness enhancing portion;
the pulley member is rotationally mechanically connected to the side wall portion of the first mounting member by the axle sub-assembly; and
the first mounting member is generally U-shaped with the base portion forming the bottom of the U-shape and the side wall portion and the stiffness enhancing portion forming the arms of the U-shape.

2. The assembly of claim 1 wherein:
the first mounting member is integrally formed;
the first mounting member is unitary; and
the first mounting member is made out of sheet metal that is bent to form its generally U-shape.

3. The assembly of claim 1 wherein the base portion of the first mounting member has at least one mounting hole formed therethrough.

4. The assembly of claim 1 further comprising a second mounting member defining a base side;
wherein:
the second mounting member includes a side wall portion, a base portion and a stiffness enhancing portion;
the pulley member is rotationally mechanically connected to the side wall portion of the second mounting member by the axle sub-assembly; and
the second mounting member is generally U-shaped with the base portion forming the bottom of the U-shape and the side wall portion and the stiffness enhancing portion forming the arms of the U-shape.

5. The assembly of claim 4 wherein:
the first mounting member includes a non-base edge;
the non-base edge of the first mounting member is shaped and sized to be suitable for substantially complete complementary nesting;
the second mounting member includes a non-base edge; and
the non-base edge of the second mounting member is shaped and sized to be suitable for substantially complete complementary nesting.

6. The assembly of claim 5 wherein:
the non-base edge of the first mounting member is shaped and sized to be suitable for complete complementary nesting; and
the non-base edge of the second mounting member is shaped and sized to be suitable for complete complementary nesting.

7. The assembly of claim 5 wherein:
the non-base edge of the first mounting member is shaped and sized to be suitable for substantially complete complementary nesting with overlap; and
the non-base edge of the second mounting member is shaped and sized to be suitable for substantially complete complementary nesting with overlap.

8. A pulley assembly comprising:
a pulley member;
an axle sub-assembly;
a first mounting member defining a base side; and
a second mounting member defining a base side;
wherein:
the first mounting member includes at least a side wall portion that defines a non-base edge;
the second mounting member includes at least a side wall portion that defines a non-base edge;
the pulley member is rotationally mechanically connected to the side wall portion of the first mounting member by the axle sub-assembly;
the pulley member is rotationally mechanically connected to the side wall portion of the second mounting member by the axle sub-assembly;
the non-base edge of the first mounting member is shaped and sized to be suitable for substantially complete complementary nesting; and
the non-base edge of the second mounting member is shaped and sized to be suitable for substantially complete complementary nesting.

9. The assembly of claim 8 wherein:
the first mounting member is integrally formed;
the first mounting member is unitary;
the first mounting member is made out of sheet metal that is bent to form its generally U-shape;
the second mounting member is integrally formed;
the second mounting member is unitary; and
the second mounting member is made out of sheet metal that is bent to form its generally U-shape.

10. The assembly of claim 8 wherein:
the non-base edge of the first mounting member is shaped and sized to be suitable for complete complementary nesting; and
the non-base edge of the second mounting member is shaped and sized to be suitable for complete complementary nesting.

11. The assembly of claim 8 wherein:
the non-base edge of the first mounting member is shaped and sized to be suitable for substantially complete complementary nesting with overlap; and
the non-base edge of the second mounting member is shaped and sized to be suitable for substantially complete complementary nesting with overlap.

12. A method of making a plurality of mounting member plates for use in pulley assemblies, the method comprising the steps of:
providing a strip of material; and
cutting a plurality of the mounting members plates out of the strip according to a cutting pattern;
wherein:
the cutting pattern is shaped and sized so that there is at least substantially complete complementary nesting.

13. The method of claim 12 wherein the cutting pattern is shaped and sized so that there is complete complementary nesting.

14. The method of claim 12 wherein the cutting pattern is shaped and sized so that there is nesting with overlap.
